(19) United States
(12) Patent Application Publication
(10) Pub. No.: US 2013/0100773 A1
(43) Pub. Date: Apr. 25, 2013

(54) WIDE-AREA WIND VELOCITY PROFILER

(71) Applicant: Steven Robert Rogers, Silver Spring, MD (US)

(72) Inventor: Steven Robert Rogers, Silver Spring, MD (US)

(21) Appl. No.: 13/278,193

(22) Filed: Oct. 21, 2011

(51) Int. Cl. G01S 15/02

(52) U.S. Cl. 367/90

(57) ABSTRACT

A wide-area wind velocity profiler, which includes two or more active sound sources and at least one receiver module, in a bistatic SODAR configuration. The profiler measures wind velocities in the atmospheric boundary layer above large geographic areas, such as wind farms or airports.

### 1. FIELD OF THE INVENTION

The present invention relates generally to wind velocity measurement by means of a remote acoustic sounding system. More specifically, the invention discloses a bistatic SODAR system for continuous monitoring of the wind velocity over large geographical areas.

### 2. BACKGROUND OF THE INVENTION

The planning and operation of wind farms covering areas of several hundred square kilometers requires a sensor for monitoring wind velocity over such large areas. Somewhat smaller areas are needed for monitoring wind conditions above airports. The ideal wide-area wind velocity profiler would operate continuously for periods of one year or more, with minimal maintenance, and would measure wind speed and direction up to heights of at least several hundred meters above local ground, or sea, level.

SODAR (SOund Detection And Ranging) is a well-known remote-sensing technique for measuring wind velocity in the atmospheric boundary layer. Monostatic SODAR uses a collection of antennae which are collocated, either in the form of individual transceiver elements, or, in more modern systems, as a phased array of transducers. A sound of a well-defined frequency is emitted in a nearly vertical direction, and the Doppler-shifted echo is received in various tilted beams around the vertical. The sound frequency is usually in the range of 1000 hertz to 4000 hertz, corresponding to acoustic wavelengths from 34 centimeters down to 8.5 centimeters. The echoes are produced by fluctuations in the atmosphere, having length scales comparable to the sound wavelength, and which travel with the mean wind velocity. By using sound pulses with pulse repetition intervals of a few seconds, echoes originating at different heights can be separated on the basis of their time of arrival.

Bistatic SODAR locates the sound receiver away from the sound source, often by hundreds of meters or more. While operationally more complicated, the bistatic geometry has several clear advantages over monostatic SODAR. These include a larger scattering cross-section for atmospheric fluctuations, enhanced signal to noise ratio, better accuracy above uneven terrain, and reduced sidelobe interference. Further details on both monostatic and bistatic SODAR systems may be found in a survey paper by R. L. Coulter and M. A. Kallistratova, entitled “Two decades of progress in SODAR techniques: a review of 11 ISARS proceedings,” which appeared in volume 85 of the journal of Meteorology and Atmospheric Physics, 2004, pages 3-19, and which is included herein by reference.

U.S. Pat. No. 4,219,887 by Paul B. MacCready Jr. and entitled “Bistatic Acoustic Wind Monitor System,” discloses a bistatic SODAR system, in which the beams of the transmitting and receiving transducers intersect at a small angle, typically less than 25 degrees. Such a geometry is appropriate for monitoring of wind velocity in relatively small geographic areas, having diameters of several hundred meters. It is unsuitable for monitoring geographical areas of several kilometers or more, where the angle between the beams of the transmitting and receiving transducers would have to be enlarged to nearly 90 degrees.

P. Behrens, S. Bradley, and S. Von Hunerbein describe a SODAR which might be applicable to large geographical areas, in a paper entitled “A scanning bi-static SODAR,” which appeared in the 14^{th} International Symposium for the Advancement of Boundary Layer Remote Sensing, 10P Conference Series: Earth and Environmental Science 1, 012010, 2008, and which is included herein by reference. In this paper, the atmospheric volume of interest is scanned by a narrow transmitted beam and a narrow received beam, which are controlled to intersect at a desired height above ground. The steering of the received beam can be done either in hardware, or in software, by means of digital beam forming. However, the need for scanning of the transmitted beam greatly increases the amount of time required to cover a large atmospheric volume. Therefore, this approach is practical for infrequent, but not for continuous, monitoring of large atmospheric volumes.

What is needed, therefore, is a bistatic SODAR system for continuous monitoring of wind velocity over large geographical areas. The present invention answers this need.

### 3. SUMMARY OF THE INVENTION

The present invention is a wide-area wind velocity profiler, comprising:

(a) a first active, sound source operating in a first frequency band and transmitting a beam of sound in a first direction,
(b) a second active sound source operating in a second frequency band and transmitting a beam of sound in a second direction,
(c) at least one receiver module oriented to receive atmospheric echoes produced by said first and second active sound sources and to convert them to electrical signals, and
(d) a signal processor for calculating wind velocity components from said electrical signals.

The primary objective of this invention is to provide a system for continuously monitoring wind velocity in the atmospheric boundary layer above large geographical areas. The invention results from the realization that the cost and complexity of a non-scanning wide-area bistatic SODAR is governed primarily by the large number of receiver modules needed to cover all grid locations in a large geographical area. In the prior-art, more than one receiver module is needed at each grid location, in order to determine the several components of the wind velocity vector. The present invention teaches that, by using at least two active sound sources, transmitting in different directions and with different frequencies, the components of the wind velocity vector may be determined with only one receiver module at each grid location. This teaching dramatically reduces system cost and complexity, thereby making it feasible to monitor wind conditions continuously over large geographical areas.

### 4. DESCRIPTION OF THE DRAWINGS

FIG. 1: Wide-Area Wind Velocity Profiler—top view

FIG. 2: Atmospheric attenuation at different sound frequencies

FIG. 3: Wide-Area Wind Velocity Profiler—side view

FIG. 4: Block diagram of receiver module and signal processor

### 5. DETAILED DESCRIPTION

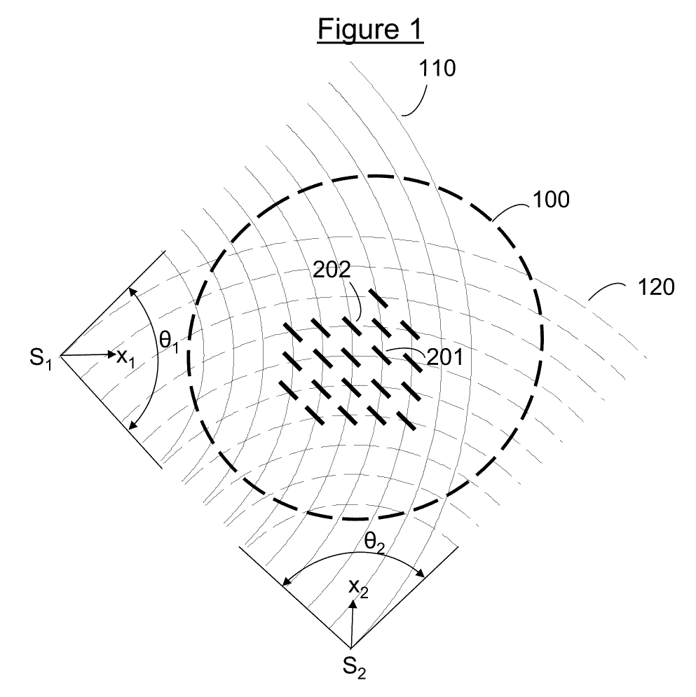

FIG. 1 shows a top view of the preferred embodiment of a wide-area wind velocity profiler according to this invention. Active sound sources S₁ and S₂ emit sound in azimuthal directions x₁ and x₂, respectively. The x₁-x₂ axes define a plane which is approximately horizontal. Perimeter 100 circumscribes the area above which wind velocity profiles are to be measured. Perimeter 100, shown by a dashed oval, may in fact have any desired shape. Angles θ₁ and θ₂ are the 3-dB azimuthal beamwidths of active sound sources S₁ and S₂, respectively. Representative values of θ₁ and θ₂ are between 10 degrees and 90 degrees. Rays drawn in directions x₁ and x₂ intersect inside perimeter 100, at an angle which is approximately 90 degrees. The multiple line segments inside perimeter 100 represent receiver modules, two of which are labeled as 201 and 202.

In the preferred embodiment, active sound sources S₁ and S₂ generate sound pulses at pulse repetition intervals of T₁ and T₂, respectively. The pulses travel outward along approximately circular arcs, which are shown by solid curves 110 for S₁ and by dashed curves 120 for S₂. At a given snapshot in time, the intersection of the solid curves with the dashed curves produces a grid inside perimeter 100 which resembles a distorted rectangular grid.

The values of the pulse repetition intervals T₁ and T₂ may or may not be equal. However, they must be large enough that the echoes produced by two successive pulses, from the same active sound source, do not overlap in time. Insofar as echoes originate at different heights in the air column above the x₁-x₂ plane, the time duration of a pulse received by a receiver pointing vertically is increased by Hₘₐₓ/C, where C is the nominal sound speed in air, and Hₘₐₓ is the maximum echo height. The value of Hₘₐₓ depend on the echo signal to noise ratio. For example, with C=340 meters per second and Hₘₐₓ=500 meters, the pulse is broadened by Hₘₐₓ/C=1.5 seconds. Representative transmitted pulse widths and pulse repetition intervals are 0.05 to 0.5 seconds, and 1 to 10 seconds, respectively.

The transmitted pulses from active sound sources S₁ and S₂ consists of pure sinusoidal waves at frequencies F₁ and F₂. Other modulations are possible, but the use of pure sinusoidal waves simplifies the determination of Doppler frequency shifts by a signal processor. Those skilled in the art will realize that many Doppler-tolerant waveforms, such as linear frequency modulation, stepped frequency modulation, chirp signals, and polyphase codes, may also be used to advantage. In the latter case, F₁ and F₂ would correspond to frequency bands, rather than single frequencies. However, for simplicity of exposition, but with no loss of generality, we elucidate the invention in the case of pure sinusoidal waves.

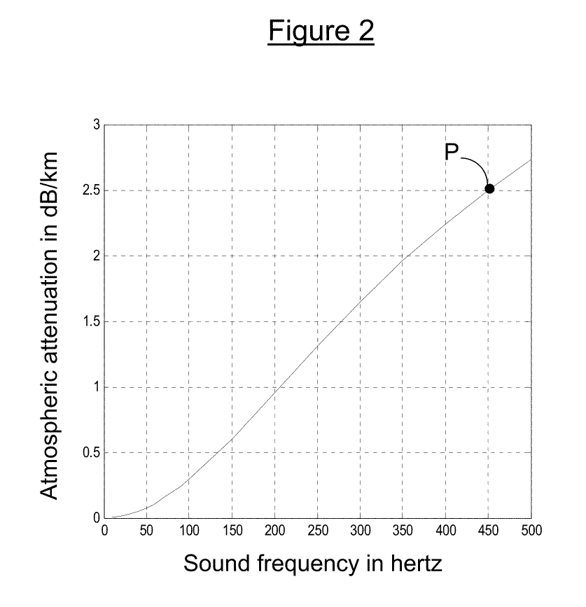

The transmitted frequencies F₁ and F₂ must be chosen to limit the amount of sound attenuation in the atmosphere, as the latter severely reduces the SODAR signal-to-noise ratio and the resulting wind velocity measurement accuracy. In a system characterized by a one-sigma wind velocity accuracy of 0.1 meters per second, the atmospheric attenuation would normally be less than 25 decibels (dB). By way of example, suppose the acoustic path length in FIG. 1 between each active sound source and all points inside perimeter 100 is ten kilometers or less. Then, the atmospheric attenuation at the transmitted frequencies should be less than 2.5 dB per kilometer. FIG. 2 shows a graph of atmospheric attenuation in dB per kilometer versus sound frequency in hertz, for air at a temperature of 20° C., a relative humidity of 50%, and a pressure of one atmosphere. Point P on the graph indicates that, under these air conditions, atmospheric attenuation below 2.5 dB per kilometer prevails at sound frequencies below 450 Hz.

Lower sound frequencies have additional advantages besides low atmospheric attenuation. Human hearing is less sensitive in the low frequency range, and therefore, higher transmitted power may be permitted while staying within mandated environmental noise limits. Furthermore, the use of low frequency sound enables direct analog-to-digital conversion in the receiver modules, and obviates the need for heterodyne hardware. This reduces hardware cost and complexity of the receiver module, which is of utmost importance for large receiver arrays.

In order to separate the Doppler-shifted echoes produced by different active sound sources, it is advantageous that the values of the transmitted frequencies, F₁ and F₂, be sufficiently far apart in frequency. The degree of frequency separation depends upon the maximum wind speed expected under normal operating conditions. The maximum wind speed, for wind farm and airport operations, will be denoted by Vₘₐₓ. A typical value for Vₘₐₓ is 25 meters per second.

Let V₁ and V₂ denote the components of the horizontal wind velocity vector in the positive x₁ and x₂ directions, respectively. V₁ and V₂ may be positive, negative, or zero. At the point of intersection of the x₁-x₂ axes, the echoes received by a directional transducer pointed in a nearly vertical direction have Doppler-shifted frequencies, F₁′ and F₂′, given approximately by the equations:

F₁′=F₁*(1−V₁/C) (equation 1a)

F₂′=F₂*(1−V₂/C) (equation 1b)

To prevent an overlap in frequency, it is necessary that:

Fₘᵢₙ/Fₘₐₓ≦(C−Vₘₐₓ)/(C+Vₘₐₓ) (equation 2)

where Fₘᵢₙ is the smaller of the two frequencies F₁ and F₂, and Fₘₐₓ is the larger. For example, with C=340 meters per second and Vₘₐₓ=25 meters per second, the factor (C−Vₘₐₓ)/(C+Vₘₐₓ) is equal to 315/365. One example of two frequencies satisfying the no-overlap condition of equation 2 is F₁=302 Hz and F₂=350 Hz. Another example is F₁=30 Hz and F₂=35 Hz.

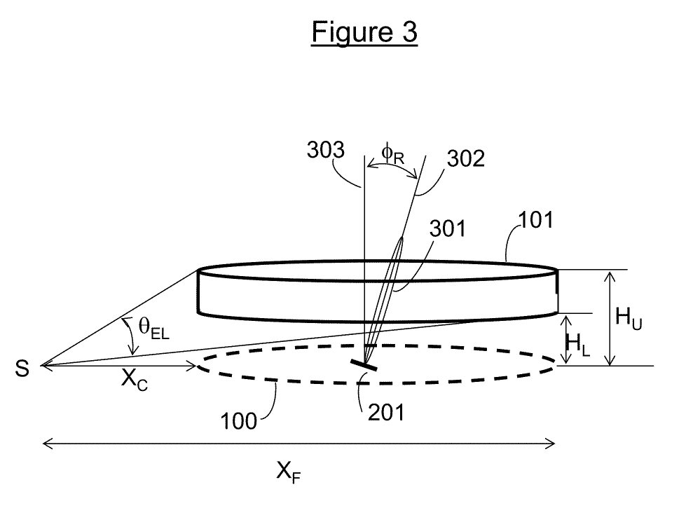

FIG. 3 shows a side view of the preferred embodiment of a wide-area wind velocity profiler according to this invention. The point S corresponds to either one of the active sound sources, S₁ and S₂ of FIG. 1. Cylinder 101 represents the atmospheric volume of interest, whose projection onto the horizontal plane is the area inside perimeter 100. H_{L} and Hᵤ denote the lower height and upper height of cylinder 101.

Receiver module 201 is typically just one of a multiplicity of receiver modules. Polar gain pattern 301 and boresight 302 represent the directional characteristics of receiver module 201. Polar gain pattern 301 may, for example, be a pencil-beam pattern, with beamwidths of three degrees or less in azimuth and elevation. Boresight 302 is offset from vertical line 303 by an angle φ_{R}. The direction of offset is away from source S, in order to reduce sidelobe clutter. The bistatic scattering cross-section for both thermal and velocity fluctuations in the atmosphere is close to zero when angle φ_{R} is zero. In order to achieve sufficient signal to noise ratio, angle φ_{R} should preferably be greater than about 5 degrees On the other hand, in order to prevent overlap with the beams of neighboring receiver modules, and to facilitate the calculation of echo height from time of arrival measurements, it is advantageous for angle φ_{R} to be less than 30 degrees.

Distances X_{c} and X_{F} are the closest and furthest distances between the sound source S and the locus of points inside perimeter 100. The 3-dB elevation beamwidth of the active sound source, denoted by θ_{EL}, is given by:

θ_{EL}=arctan(Hᵤ/X_{c})−arctan(H_{L}/X_{F}) (equation 3)

Exemplary values are H_{L}=30 meters, Hᵤ=500 meters, X_{c}=5000 meters, H_{F}=15000 meters, and θ_{EL}=5.6 degrees. In this example, the beamwidth of the active sound source is rather narrow in elevation. This can be achieved in practice by means of an active sound source consisting of a phased array of two or more coherent source elements. The use of a phased array offers an advantage, in that a null in the sound pattern can be directed towards the ground, thereby minimizing ground clutter. Another measure to reduce ground clutter is to surround the active sound source with sound absorbing materials, so as to inhibit the transmission of sound in directions that do not intersect the atmospheric volume of interest.

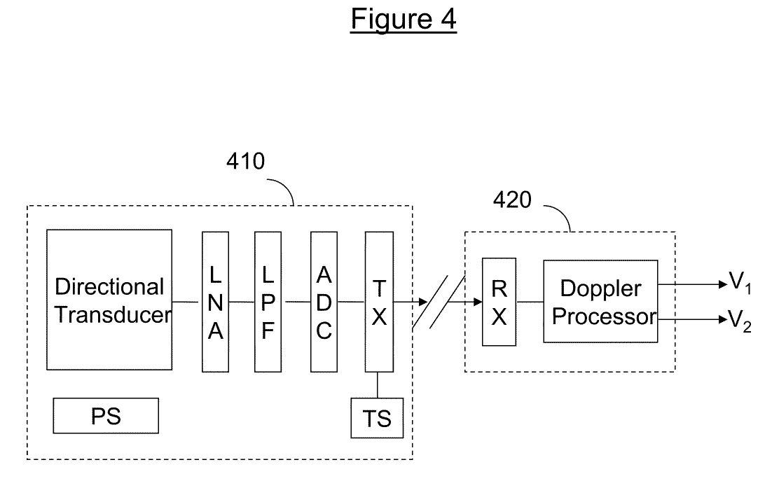

FIG. 4 shows a block diagram of a receiver module. 410 and signal processor 420. Receiver module 410 contains a directional transducer, which converts acoustic echoes into electrical signals. The directional transducer may simply be a directional microphone. Alternatively, it may be a microphone in combination with a parabolic dish reflector, or even an array of several microphones whose signals are combined with appropriate phase delays. The key factors in choosing the directional transducer are cost, sensitivity, and durability. Additional components in the receiver module are a power supply (PS), a low-noise amplifier (LNA), a low-pass filter (LPF) for noise rejection, an analog-to-digital converter (ADC), a wireless radio transmitter (TX) for sending data to signal processor 420 by means of telemetry, and an optional temperature sensor (TS) for making corrections to the local sound velocity.

Signal processor 420 contains a wireless radio receiver (RX) and a Doppler processor. Usually, only one signal processor receives and processes the data from all of the receiver modules. The number of receiver modules is equal to the number of measurement grid locations inside perimeter 100, and can easily be one hundred or more. For this reason, the Doppler processor must be very powerful and its architecture should be optimized for executing the Fast Fourier Transform (FFT). FFT's are used to determine the Doppler-shifted frequencies F₁′ and F₂′, from which the wind velocity components V₁ and V₂ may be inferred using equations similar to equations 1a and 1b above.

### 6. EXTENSIONS OF THE INVENTION

It is evident that there are many possible extensions and generalizations to the embodiments presented above.

For example, in some applications, it is necessary to measure not only the horizontal components, but also the vertical component of the wind velocity vector, even though the latter is generally less than 1 meter per second in magnitude. Those skilled in the art will realize that, by a straightforward extension of the present disclosure, a third active sound source will permit the simultaneous determination of all 3 wind velocity components, again using only one receiver module at each measurement grid location. In this case, it is advantageous to utilize three non-overlapping frequencies—F₁, F₂, and F₃—one for each of the three active sound sources.

Other extensions have been pointed out in the body of the disclosure. For example, a variety of Doppler-tolerant waveforms have been mentioned, which may be used for the active sound transmission, instead of sinusoidal waves modulated in amplitude by a train of pulses. In some applications, this may yield significant improvements in signal to noise, or signal to clutter ratios.

Thus, while the invention has been described with respect to certain embodiments by way of example, it will be appreciated that the present invention is not limited to what has been particularly shown and described. Rather, the scope of the present invention includes both combinations and sub-combinations of the various features described above, as well as variations and modifications thereof which would occur to persons skilled in the art upon reading the foregoing description and which are not disclosed in the prior art.

1. In a wide-area wind velocity profiler, the combination comprising:
(a) a first active sound source operating in a first frequency band and transmitting a beam of sound in a first direction,
(b) a second active sound source operating in a second frequency band and transmitting a beam of sound in a second direction,
(c) at least one receiver module oriented to receive atmospheric echoes produced by said first and second active sound sources and to convert them to electrical signals, and
(d) a signal processor for calculating wind velocity components from said electrical signals.

2. The combination of claim 1, wherein said first and second frequency bands have sufficient separation in frequency to prevent atmospheric echoes from overlapping in frequency, for wind speeds below a prescribed upper limit.

3. The combination of claim 1, wherein said first and second frequency bands are below 450 hertz.

4. The combination of claim 1, wherein said first and second directions intersect at an angle of approximately 90 degrees.

5. The combination of claim 1, wherein said receiver module is comprised of a directional transducer for receiving atmospheric echoes.

6. The combination of claim 1, wherein said receiver module is characterized by a pencil-beam gain pattern.

7. The combination of claim 1, wherein said receiver module is characterized by a boresight which is offset by more than 5 degrees from vertical.

8. The combination of claim 1, wherein said receiver module is characterized by a boresight which is offset by less than 30 degrees from vertical.

9. The combination of claim 1, further comprising a third active sound source operating in a third frequency band and transmitting a beam of sound in a third direction.

10. A method for determining multiple components of a wind velocity vector, utilizing two or more active sound sources, wherein said active sound sources operate in different frequency bands, and transmit beams of sound in different directions.
